(19) United States
(12) Patent Application Publication
(10) Pub. No.: US 2017/0060408 A1
(43) Pub. Date: Mar. 2, 2017

(54) ELECTRONIC DEVICE AND METHOD FOR APPLICATIONS CONTROL

(71) Applicant: Chiun Mai Communication Systems, Inc., New Taipei (TW)

(72) Inventor: YUEH-CHI WANG, New Taipei (TW)

(21) Appl. No.: 15/247,946

(22) Filed: Aug. 26, 2016

(30) Foreign Application Priority Data
Aug. 31, 2015 (CN) 201510546208.8

(51) Int. Cl. G06F 3/0488; G06F 3/0481; G06F 3/0483

(52) U.S. Cl. CPC G06F 3/04883; G06F 3/0483; G06F 3/04817

(57) ABSTRACT

A method for controlling applications in an electronic device through manipulation of icons of the applications includes activating a selection mode of the electronic device by detecting a predetermined user operation on a touch screen of the electronic device. A path of a sliding touch on a touch screen of the electronic device is detected and recognized. A folder is created at the start or end of the path of the sliding. When the path is closed by returning the sliding touch to the start point of the path, application icons of installed applications which are within the interior of the closed path are moved into the folder.

### CROSS-REFERENCE TO RELATED APPLICATIONS

This application claims priority to Chinese Patent Application No. 201510546208.8 filed on Aug. 31, 2015, the contents of which are incorporated by reference herein.

### FIELD

The subject matter herein generally relates to applications management, and particularly to an electronic device and a method for controlling applications of the electronic device.

### BACKGROUND

Electronic devices, such as mobile phones, are increasingly equipped with more functions. Display sequences of such applications may be fixed. It may be inconvenient for users to always sort applications of the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a controlling system.

FIG. 2 is a block diagram of one embodiment of modules of the controlling system of FIG. 1.

FIG. 3 illustrates a flowchart of one embodiment of a method for controlling applications of the electronic device of FIG. 1.

FIG. 4 illustrates an example of a closed path generated by sliding on a page of a home desktop of the electronic device of FIG. 1.

FIG. 5 illustrates an example of a closed path generated by sliding between several pages of the home desktop of the electronic device of FIG. 1.

FIG. 6 illustrates an example of an open path generated by sliding on a page of the home desktop of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

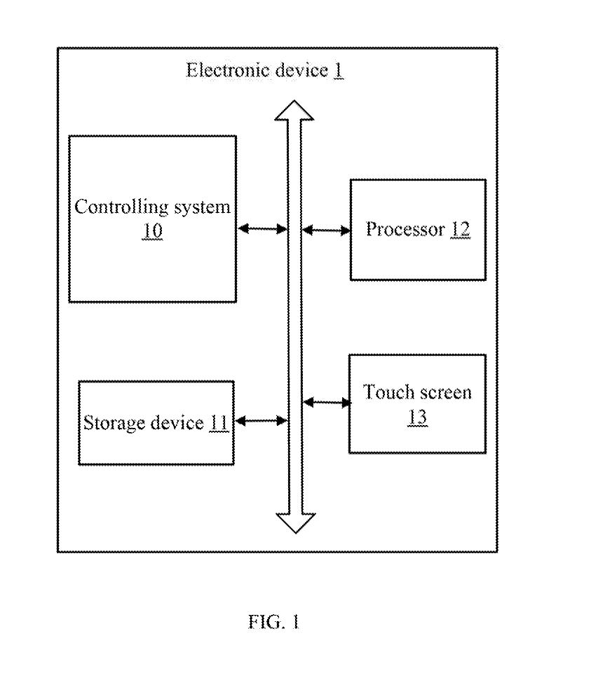

FIG. 1 is a block diagram of one embodiment of an electronic device. Depending on the embodiment, the electronic device 1 can include, but is not limited to, a controlling system 10, a storage device 11, at least one processor 12, and a touch screen 13. The above components communicate with each other through a system bus. In at least one embodiment, the electronic device 1 can be a mobile phone, a tablet computer, a personal digital assistant, or any other suitable device configured with a touch function. FIG. 1 illustrates only one example of the electronic device 1 that can include more or fewer components than illustrated, or have a different configuration of the various components in other embodiments.

In at least one embodiment, the storage device 11 can be a memory of the electronic device 1. In other embodiments, the storage device 11 can be a secure digital card, or other external storage device such as a smart media card. In at least one embodiment, the storage device 11 can store many applications. Each application may be represented by an application icon displayed on the touch screen 13.

The at least one processor 12 can be a central processing unit (CPU), a microprocessor, or other data processor chip that performs functions of the electronic device 1.

In at least one embodiment, the touch screen 13 can be a liquid crystal display (LCD) or an organic light-emitting diode (OLED) display screen. The touch screen 13 can detect touches on one or more positions of the touch screen 13 which are input by a user. The detectable touches include the user applying any touch on the touch screen 13, a contact position generated by the touch on the touch screen 13, and whether the touch on the touch screen 13 moves or is stationary.

In at least one embodiment, the controlling system 10 can move icons of the applications, which are displayed on the touch screen 13, into a folder that is created by a user.

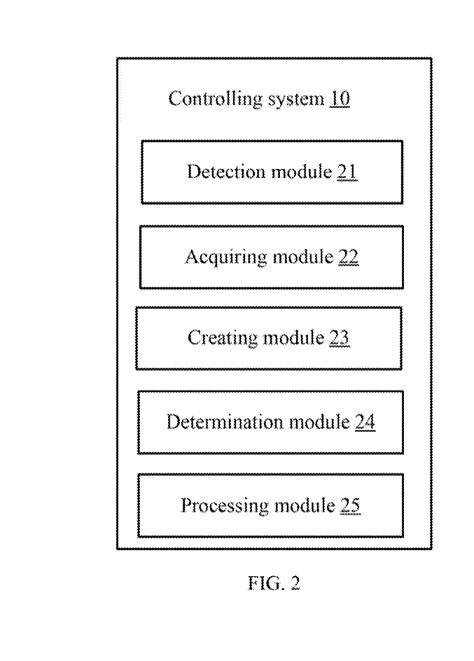

FIG. 2 illustrates a block diagram of one embodiment of modules of the controlling system 10. In at least one embodiment, the controlling system 10 can include a detection module 21, an acquiring module 22, a creating module 23, a determination module 24, and a processing module 25. The modules 21-25 include computerized codes in the form of one or more programs that may be stored in the storage device 11. The computerized codes include instructions that are executed by the at least one processor 12.

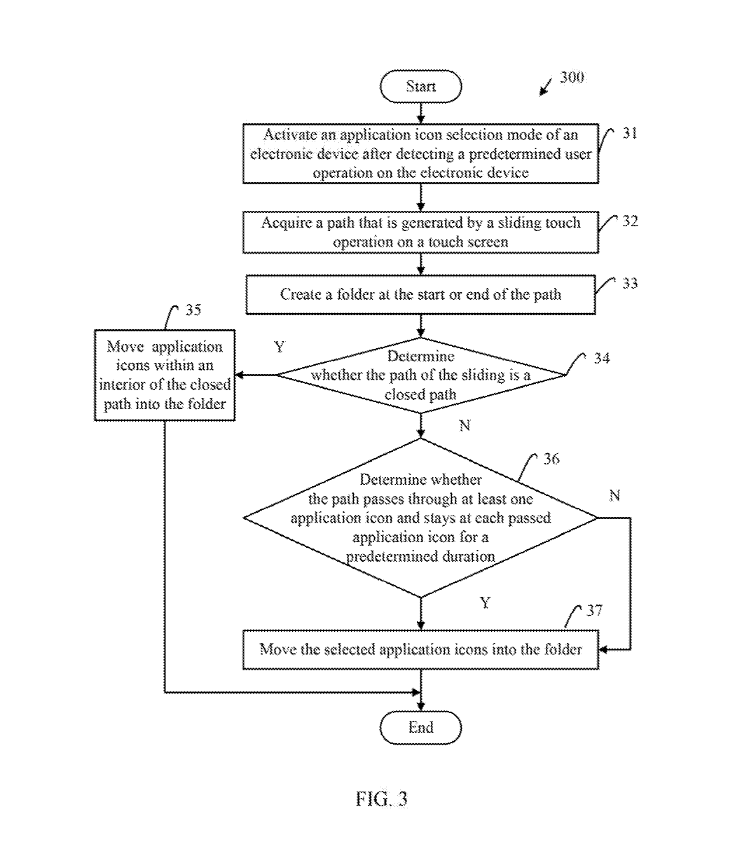

FIG. 3 illustrates a flowchart which is presented in accordance with an example embodiment. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Additionally, the illustrated order of blocks is by example only and the order of the blocks can be changed according to the present disclosure. The example method 300 can begin at block 31. Depending on the embodiment, additional steps can be added, others removed, and the ordering of the steps can be changed.

At block 31, the detection module 21 can activate an application icon selection mode of the electronic device 1 after detecting a predetermined user operation on the electronic device 1. In at least one embodiment, the predetermined user operation includes a slide operation on the touch screen 13, a long press on any point of the touch screen 13, a press on a predetermined physical button (e.g. a home key) of the electronic device 1, and a press on a predetermined virtual button of the electronic device 1. In the application icon selection mode, at least one application icon can be selected by a sliding touch operation on the touch screen 13. For example, in the application icon selection mode, a user can select application icons by sliding through the application icons, or the user can select application icons by circling the application icons.

At block 32, the acquiring module 22 can acquire a path that is generated by a sliding touch operation on the touch screen 13. In at least one embodiment, the generated path includes a starting position 41 and an ending position 42 displayed on the touch screen 13.

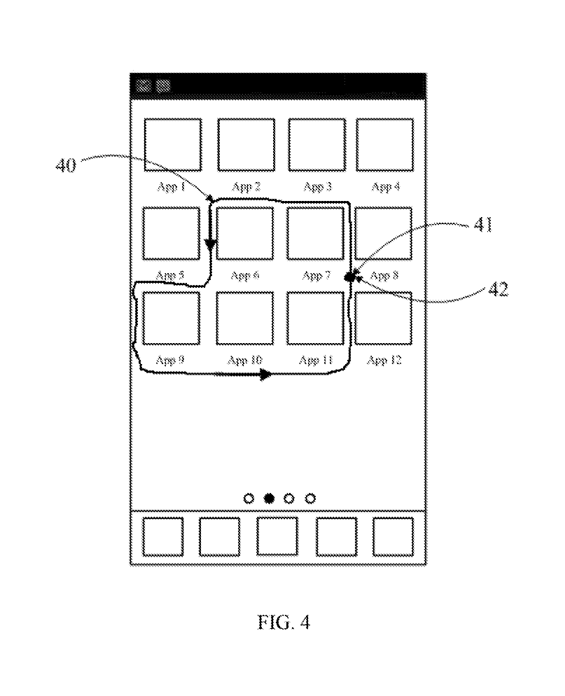

In at least one embodiment, the touch screen 13 can display a home desktop of the electronic device 1, the home desktop can include one or more pages. Each page of the home desktop includes one or more application icons, as shown in FIG. 4, for example. Before the application icon selection mode is activated, the user can slide a finger or a tool such as a stylus horizontally across the touch screen 13 to trigger the home desktop to turn pages. In at least one embodiment, a horizontal slide operation on the touch screen 13 in the application icon selection mode does not trigger the home desktop of the electronic device 1 to turn pages, and the home desktop of the electronic device 1 is triggered to turn pages when the horizontal slide operation moves to a left border or a right border of the home desktop and stays at the left border or the right border for a predetermined duration in the application icon selection mode.

In at least one embodiment, before the application icon selection mode is activated, the user can slide a finger or a tool such as a stylus vertically across the touch screen 13 to trigger the home desktop to turn pages. In at least one embodiment, a vertical slide operation on the touch screen in the application icon selection mode does not trigger the home desktop of the electronic device 1 to turn pages, and the home desktop of the electronic device 1 is triggered to turn pages when the vertical slide operation moves to a top border or a bottom border of the home desktop and stays at the top border or the bottom border for a predetermined duration in the application icon selection mode.

In at least one embodiment, the direction of the predetermined user operation to activate the application icon selection mode is different from the direction of the slide operation to turn pages of the home desktop. For example, in a sliding operation as the predetermined user operation to activate the application icon selection mode, when the direction of the slide operation to trigger the home desktop to turn pages is to the left or the right, the direction of the slide operation to activate the application icon selection mode will be up or down. When the direction of the slide operation to trigger the home desktop to turn pages is up or down, the direction of the slide operation to activate the application icon selection mode will be to the left or the right.

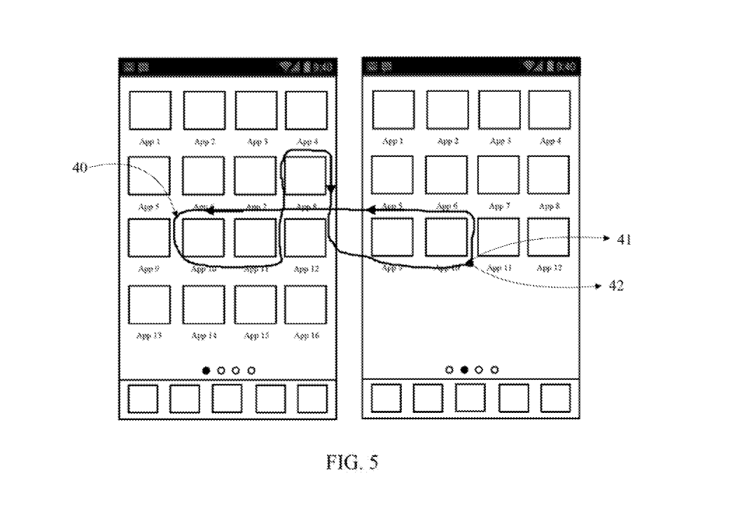

In at least one embodiment, FIG. 4 shows an example of a path of a sliding generated on the home desktop page in response to the slide operation. The path of a sliding can be generated between and over several pages of the home desktop, as shown in FIG. 5. For example, the path can be generated on the current page of the home desktop when the user slides from the top to the bottom of the touch screen 13. The path can be generated on the current page of the home desktop when the user slides from the bottom to the top of the touch screen 13. The path can be generated on the current page of the home desktop when the user slides from the left to the right of the touch screen 13. The path can be generated on the current page of the home desktop when the user slides from the right to the left of the touch screen 13. The path also can be generated on the current page of the home desktop when the user slides along an arbitrarily curve track on the touch screen 13.

At block 33, the creating module 23 can create a folder at the start or the end of the path. In at least one embodiment, the creating module 23 can acquire a starting position 41 and an ending position 42 of the slide operation on the touch screen, and can create the folder at the starting position 41 or the ending position 42.

At block 34, the determination module 24 can determine whether the path of the sliding is a closed path. In at least one embodiment, the determination module 24 can determine whether the starting position 41 is the same as the ending position 42. When the starting position 41 is the same as the ending position 42, the path is determined to be closed, and the process goes to block 35. When the starting position 41 is different from the ending position 42, the path is determined to be not closed, and the process goes to block 36.

At block 35, the processing module 25 can move the application icons within the interior of the closed path into the folder. For example, as shown in FIG. 4, when the path is closed, the processing module 25 can move application icons App 6, App 7, App 9, App 10, and App 11 into the folder. As shown in FIG. 5, when the path is closed, the processing module 25 can move application icons App 8, App 10, and App 11 on the left hand home desktop and application icons App 9, and App 10 on the right hand home desktop into the folder. The processing module 15 can quickly move scattered application icons into the folder.

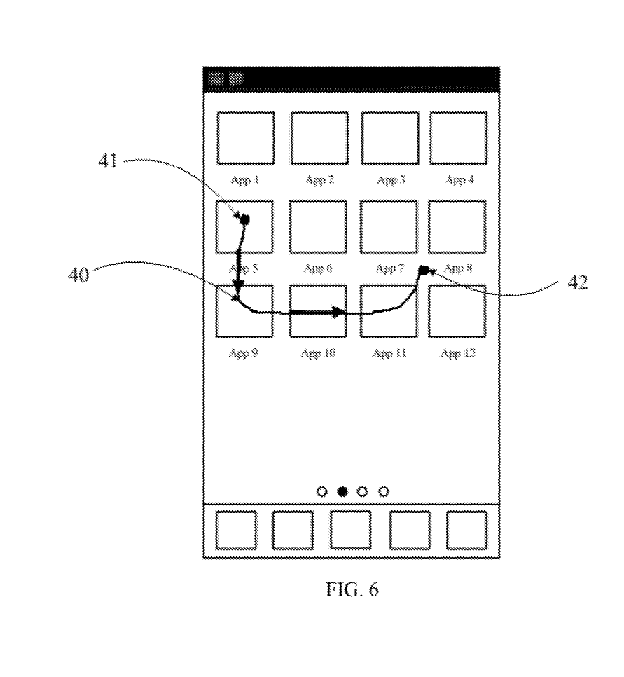

At block 36, the determination module 24 can determine whether the path passes through at least one application icon and stays at each passed application icon for a predetermined duration (e.g., 0.5 seconds). When the path passes through at least one application icon, as in FIG. 6 for example, and stays at each passed application icon for the predetermined duration, it is determined that that the at least one passed application icon is selected, and the process goes to block 37. When the path does not traverse any application icon or does not stay at any application icon for the predetermined duration, it is determined that no application icon is selected, and the process ends.

In at least one embodiment, the path can pass through one or more application icons for selecting applications. The determination module 24 can set a predetermined position of the application icon as a point used for selecting the application, for example, the center point of the application icon. When the path passes through the predetermined position of an application icon and stays at the predetermined position of the application icon for the predetermined duration, it is determined that such application icon is selected. For example, when the path passes through the centers of the application icons and stays at the centers of each application icon for the predetermined duration, it is determined that the application icons are selected.

At block 37, the processing module 25 can move the selected application icons into the folder. For example, as shown in FIG. 6, the processing module 25 can move the application icons App 5, App 9, App 10, and App 11 into the folder.

In at least one embodiment, when the path is not closed, but the path passes through an application icon and stays at the application icon or at its marking point for the predetermined duration, the processing module 15 can move the application icon into the folder.

In at least one embodiment, when the path is closed, and there is already an existing folder within the interior of the closed path, the processing module 25 can move all applications icons in the existing folder into the created folder, accordingly, the existing folder becomes empty or can be deleted by the processing module 25.

In at least one embodiment, when the path is not closed, and the path passes through a folder and stay at the folder for a predetermined duration, the processing module 25 can move all application icons in the folder that the path passes and stays at into the created folder, and the folder that the path passes and stays at becomes empty or can be deleted by the processing module 25.

In other embodiments, a detection module 21, an acquiring module 22, a creating module 23, a determination module 24, and a processing module 25 of the controlling system 10 can be hardware or firmware.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A controlling method applied in an electronic device, the electronic device comprising a touch screen and a storage device that stores a plurality of applications, each application represented by an application icon displayed on the touch screen, the method comprising:
activating an application icon selection mode of the electronic device after detecting a predetermined user operation on the electronic device;
acquiring in the application icon selection mode a path that is generated by a sliding touch operation on the touch screen;
creating a folder at a start or an end of the path; and
moving the application icons within an interior of the path into the folder when the path is a closed path.

2. The method according to claim 1, further comprising:
when the path is a closed path and there is already an existing folder within the interior of the closed path, moving all applications icons in the existing folder into the created folder.

3. The method according to claim 1, further comprising:
determining whether the path passes through at least one application icon and stays at each passed application icon for a predetermined duration when the path is not a closed path; and
moving the application icons that the path passes and stays at into the created folder.

4. The method according to claim 1, further comprising:
moving an application icon into the created folder when the path begins at or ends at the application icon and stay at the application icon for a predetermined duration and the path is not a closed path.

5. The method according to claim 1, further comprising:
when the path passes through a folder and stay at the folder for a predetermined duration and the path is not a closed path, moving all application icons in the folder that the path passes and stays at into the created folder.

6. The method according to claim 1, wherein the predetermined user operation comprises:
a slide operation on the touch screen, a long press on any point of the touch screen, a press on a predetermined physical button of the electronic device, or a press on a predetermined virtual button of the electronic device.

7. The method according to claim 6, wherein a direction of the predetermined user operation to activate the application icon selection mode is different from a direction of a slide operation to trigger a home desktop of the electronic device to turn pages when the application icon selection mode is not activated.

8. The method according to claim 7, wherein a horizontal slide operation on the touch screen in the application icon selection mode does not trigger the home desktop of the electronic device to turn pages, and the home desktop of the electronic device is triggered to turn pages when the horizontal slide operation moves to a left border or a right border of the home desktop and stay at the left border or the right border for a predetermined duration in the application icon selection mode.

9. The method according to claim 7, wherein a vertical slide operation on the touch screen in the application icon selection mode does not trigger the home desktop of the electronic device to turn pages, and the home desktop of the electronic device is triggered to turn pages when the vertical slide operation moves to a top border or a bottom border of the home desktop and stay at the top border or the bottom border for a predetermined duration in the application icon selection mode.

10. An electronic device comprising:
a touch screen;
a storage device that stores a plurality of applications, and each application represented by an application icon displayed on the touch screen;
at least one processor; and
the storage device further stores one or more programs that, when executed by the at least one processor, cause the at least one processor to:
activate an application icon selection mode of the electronic device after detecting a predetermined user operation on the electronic device;
acquire in the application icon selection mode a path that is generated by a sliding touch operation on the touch screen;
create a folder at a start or an end of the path; and
move the application icons within an interior of the path into the folder when the path is a closed path.

11. The electronic device according to claim 10, wherein the at least one processor further caused to:
when the path is a closed path and there is already an existing folder within the interior of the closed path, move all applications icons in the existing folder into the created folder.

12. The electronic device according to claim 10, wherein the at least one processor further caused to:
determine whether the path passes through at least one application icon and stays at each passed application icon for a predetermined duration when the path is not a closed path; and
move the application icons that the path passes and stays at into the created folder.

13. The electronic device according to claim 10, wherein the at least one processor further caused to:
move an application icon into the created folder when the path begins at or ends at the application icon and stay at the application icon for a predetermined duration and the path is not a closed path.

14. The electronic device according to claim 10, wherein the at least one processor further caused to:
when the path passes through a folder and stay at the folder for a predetermined duration and the path is not a closed path, move all application icons in the folder that the path passes and stays at into the created folder.

15. The electronic device according to claim 10, wherein the predetermined user operation comprises:
a slide operation on the touch screen, a long press on any point of the touch screen, a press on a predetermined physical button of the electronic device, or a press on a predetermined virtual button of the electronic device.

16. The electronic device according to claim 15, wherein a direction of the predetermined user operation to activate the application icon selection mode is different from a direction of a slide operation to trigger a home desktop of the electronic device to turn pages when the application icon selection mode is not activated.

17. The electronic device according to claim 16, wherein a horizontal slide operation on the touch screen in the application icon selection mode does not trigger the home desktop of the electronic device to turn pages, and the home desktop of the electronic device is triggered to turn pages when the horizontal slide operation moves to a left border or a right border of the home desktop and stay at the left border or the right border for a predetermined duration in the application icon selection mode.

18. The electronic device according to claim 16, wherein a vertical slide operation on the touch screen in the application icon selection mode does not trigger the home desktop of the electronic device to turn pages, and the home desktop of the electronic device is triggered to turn pages when the vertical slide operation moves to a top border or a bottom border of the home desktop and stay at the top border or the bottom border for a predetermined duration in the application icon selection mode.

19. A non-transitory storage medium having stored thereon instructions that, when executed by a processor of an electronic device, causes the processor to perform a controlling method, the electronic device comprising a touch screen and a storage device that stores a plurality of applications, and each application represented by an application icon displayed on the touch screen, wherein the method comprises:
activating an application icon selection mode of the electronic device after detecting a predetermined user operation on the electronic device;
acquiring in the application icon selection mode a path that is generated by a sliding touch operation on the touch screen;
creating a folder at a start or an end of the path; and
moving the application icons within an interior of the path into the folder when the path is a closed path.

20. The non-transitory storage medium according to claim 19, further comprising:
when the path is a closed path and there is already an existing folder within the interior of the closed path, moving all applications icons in the existing folder into the created folder.

21. The non-transitory storage medium according to claim 19, further comprising:
determining whether the path passes through at least one application icon and stays at each passed application icon for a predetermined duration when the path is not a closed path; and
moving the application icons that the path passes and stays at into the created folder.

22. The non-transitory storage medium according to claim 19, further comprising:
moving an application icon into the created folder when the path begins at or ends at the application icon and stay at the application icon for a predetermined duration and the path is not a closed path.

23. The non-transitory storage medium according to claim 19, further comprising:
when the path passes through a folder and stay at the folder for a predetermined duration and the path is not a closed path, moving all application icons in the folder that the path passes and stays at into the created folder.

24. The non-transitory storage medium according to claim 19, wherein the predetermined user operation comprises:
a slide operation on the touch screen, a long press on any point of the touch screen, a press on a predetermined physical button of the electronic device, or a press on a predetermined virtual button of the electronic device.

25. The non-transitory storage medium according to claim 24, wherein a direction of the predetermined user operation to activate the application icon selection mode is different from a direction of a slide operation to trigger a home desktop of the electronic device to turn pages when the application icon selection mode is not activated.

26. The non-transitory storage medium according to claim 25, wherein a horizontal slide operation on the touch screen in the application icon selection mode does not trigger the home desktop of the electronic device to turn pages, and the home desktop of the electronic device is triggered to turn pages when the horizontal slide operation moves to a left border or a right border of the home desktop and stay at the left border or the right border for a predetermined duration in the application icon selection mode.

27. The non-transitory storage medium according to claim 25, wherein a vertical slide operation on the touch screen in the application icon selection mode does not trigger the home desktop of the electronic device to turn pages, and the home desktop of the electronic device is triggered to turn pages when the vertical slide operation moves to a top border or a bottom border of the home desktop and stay at the top border or the bottom border for a predetermined duration in the application icon selection mode.
